(19) United States
(12) Patent Application Publication
(10) Pub. No.: US 2003/0129358 A1
(43) Pub. Date: Jul. 10, 2003

(54) Method and medium for decoration

(75) Inventor: Fei-Chen Lee, Yung He City (TW)

Correspondence Address: Webb Ziesenheim Logsdon Orkin & Hanson, P.C., 700 Koppers Building, 436 Seventh Avenue, Pittsburgh, PA, 15219-1818, US

(73) Assignee: BEAUTONE CO., LTD.

(21) Appl. No.: 10/038,007

(22) Filed: Jan. 4, 2002

(51) Int. Cl. B32B 3/10

(52) U.S. Cl. 428/138

(57) ABSTRACT

A medium for decoration includes a cover sheet having a cover color and a plurality of holes thereon so as to form a certain pattern; at least one replaceable colored sheet which is replaceably placed behind the cover sheet so that the colored sheet is exposed to the cover sheet through the plurality of holes. Each of the plurality of holes has a particular shape and the plurality of holes have a particular distribution so as to form the certain pattern. When one colored sheet is replaced by another one, a color exposed to the cover sheet through the plurality of holes is accordingly changed so as to change the color of the certain pattern. A method for decoration is also provided.

### FIELD OF THE INVENTION

The present invention is related to a method and medium for decoration, and more particularly, to a method and medium for decoration which are adapted to be used with a paper holder, a briefcase, a diary, or the like.

### BACKGROUND OF THE INVENTION

Please refer to FIG. 1 and FIG. 2. Typically, a paper holder 10 comprises a cover sheet 11; a first inner sheet 13 with an area smaller than that of the cover sheet 11 which is secured on the inner surface 12 of the cover sheet 11 along two edges A, B so as to provide a space between the cover sheet 11 and the first inner sheet 13 for holding papers; a bottom sheet 15 extending from the cover sheet 11 and having a same area as that of the cover sheet 11; and a second inner sheet 17 having a same area as that of the first inner sheet 13 which is secured on the inner surface 14 of the bottom sheet 15 along two edges C, D so as to provide a space between the bottom sheet 15 and said second inner sheet 17 for holding papers 19.

According to the prior art, the cover sheet 11 and the bottom sheet 15 are plain and mono-colored such that the appearance of the paper holder 10 is too plain to be recognized. For example, two paper holders with a same color are hard to be distinguished from each other. This traditional design is helpless for a user to recognize one paper holder from the other ones.

Therefore, it is tried to rectify this drawback by the present invention.

### SUMMARY OF THE INVENTION

It is therefore a primary objective of the present invention to provide a method and medium for decoration which is easily recognizable.

According to the present invention, a paper holder comprises a cover sheet, a bottom sheet, a first inner sheet, and a second inner sheet, wherein the first and the second inner sheets are separately secured on the inner surfaces of the cover sheet and the bottom sheet so as to provide spaces for holding papers. Particularly, a plurality of holes are formed on each of the cover sheet and the bottom sheet. The configuration of the plurality of holes can be designed to make the paper holder showy, accordingly, to help users to distinguish one paper holder from the other ones.

Preferably, each of the plurality of holes has a particular shape.

Preferably, the plurality of holes have a particular distribution.

Preferably, the plurality of holes are formed by die-cutting.

Preferably, the first and the second inner sheets have areas smaller than that of the cover sheet and the bottom sheet.

According to the present invention, a method for decoration includes steps of preparing a cover sheet having a cover color and a plurality of holes thereon so as to form a certain pattern; and preparing at least one replaceable colored sheet which is replaceable placed behind the cover sheet so that the colored sheet is exposed to the cover sheet through the plurality of holes.

Preferably, each of the plurality of holes has a particular shape.

Preferably, the plurality of holes have a particular distribution.

Preferably, the plurality of holes are formed by die cutting.

According to the present invention, a medium for decoration includes a cover sheet having a cover color and a plurality of holes thereon so as to form a certain pattern; and at least one replaceable colored sheet which is replaceable placed behind said cover sheet so that the colored sheet is exposed to the cover sheet through the plurality of holes.

Preferably, each of the plurality of holes has a particular shape.

Preferably, the plurality of holes have a particular distribution.

Preferably, the plurality of holes are formed by die-cutting.

Preferably, the medium for decoration is attached to a cover of a briefcase.

Preferably, the medium for decoration is attached to a cover of a diary.

The foregoing and other features and advantages of the present invention will be more clearly understood through the following descriptions with reference to the drawings, wherein:

### BRIEF DESCRIPTION OF THE DRAWING

FIG. 1 shows a paper holder in a closed condition according to the prior art;

FIG. 2 shows a paper holder in an open condition according to the prior art;

FIG. 3 shows a paper holder in a closed condition according to the present invention;

FIG. 4 shows a paper holder in an open condition according to the present invention;

FIG. 5 shows a briefcase which is attached with a medium for decoration according to the present invention; and

FIG. 6 shows a diary which is attached with a medium for decoration according to the present invention.

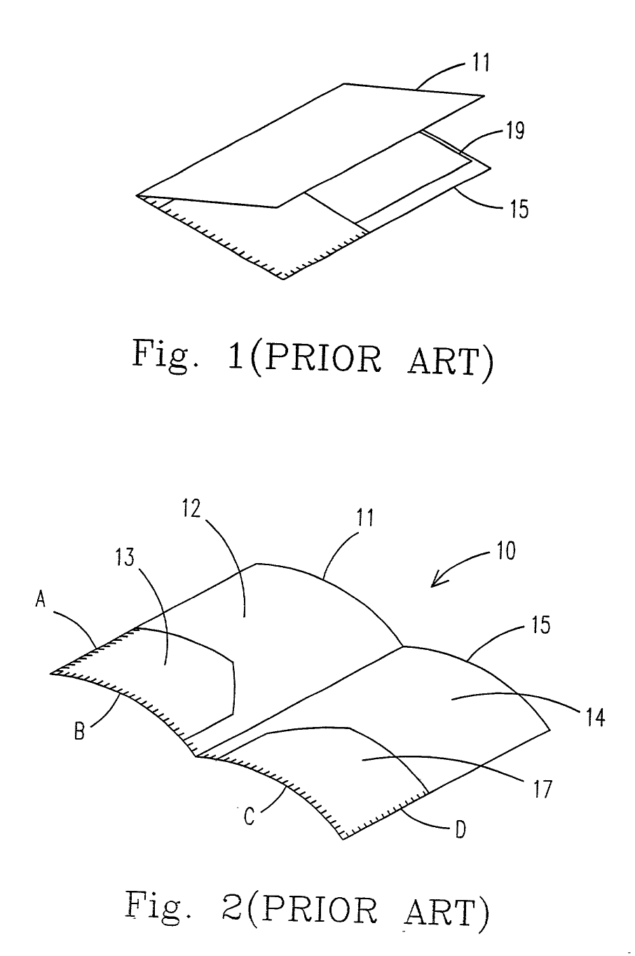

### DETAILED DESCRIPTION OF THE PREFERRED EMBODIMENTS

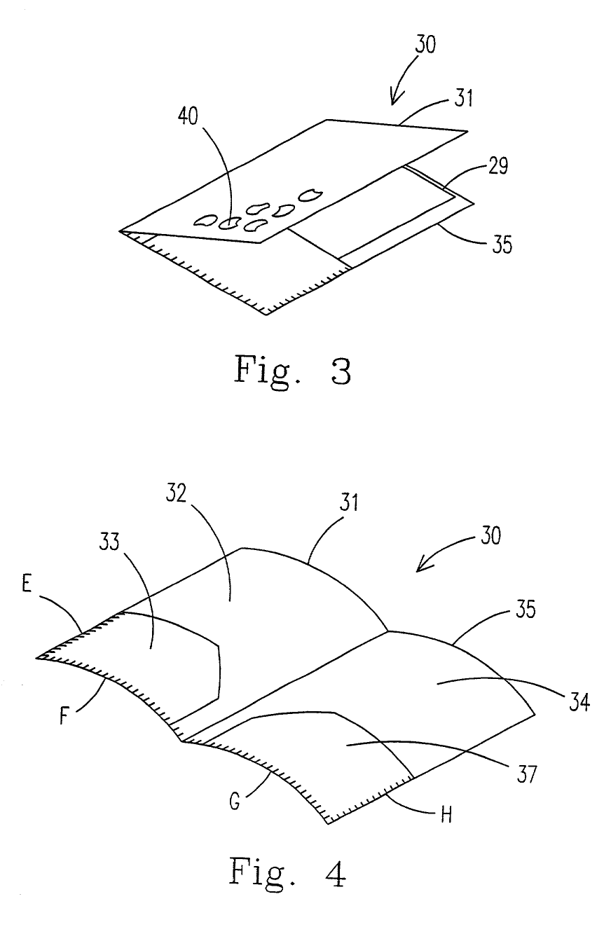

Please refer to FIG. 3 and FIG. 4. According to the present invention, a paper holder 30 includes a cover sheet 31 having a plurality of holes 40 thereon; a first inner sheet 33 with an area smaller than that of the cover sheet 31, which is secured on the inner surface 32 of the cover sheet 31 along two edges E, F, and has a first color different from the color of the cover sheet 31 so as to provide a space between the cover sheet 31 and the first inner sheet 33 for holding papers; a bottom sheet 35 which extends from the cover sheet 31 and has an area same as that of the cover sheet 31; and a second inner sheet 37 with an area smaller than that of said bottom sheet 35 which is secured on the inner surface 34 of the bottom sheet 35 along two edges G, H so as to provide a space between the bottom sheet 35 and the second inner sheet 37 for holding papers 39.

Preferably, the bottom sheet 35 further includes a plurality of holes thereon (not shown). The second inner sheet 37 has a second color different from that of said bottom sheet 35. Preferably, the holes of cover sheet 31 and bottom sheet 35 are formed by die-cutting.

In the present invention, a plurality of holes 40 are formed on the cover sheet 31 or/and the bottom sheet 35 Moreover, the color of the inner sheets 33, 37 are different from that of the cover (bottom) sheet 31 (35) such that, when there is no paper held in the paper holder 30, the color of the inner sheets 33, 37 is exposed to the cover sheet 31 or/and bottom sheet 35. This will help users to recognize the paper holder.

Specifically, the distribution of the plurality of holes 40 and the shape of each of the plurality of holes can be designed to make the paper holder showy, accordingly, to help users to distinguish one paper holder from the other ones.

For example, a user can classify his paper holders according to the colors of the inner sheets 33, 37 which are exposed to the cover/bottom sheet 31(35), the shape of hole 40, or the distribution of the holes 40.

According to an aspect of the present invention, a method for decoration includes steps of preparing a cover sheet having a cover color and a plurality of holes thereon so as to form a certain pattern; and preparing at least one replaceable colored sheet which is replaceably placed behind said cover sheet so that the colored sheet is exposed to the cover sheet through said plurality of holes.

Preferably, each of the plurality of holes has a particular shape.

Preferably, the plurality of holes have a particular distribution.

Preferably, the plurality of holes are formed by die cutting.

According to another aspect of the present invention, a medium for decoration includes a cover sheet having a cover color and a plurality of holes thereon so as to form a certain pattern; and at least one replaceable colored sheet which is replaceably placed behind said cover sheet so that said colored sheet is exposed to said cover sheet through said plurality of holes.

Preferably, each of the plurality of holes has a particular shape.

Preferably, the plurality of holes have a particular distribution.

Preferably, the plurality of holes are formed by die-cutting.

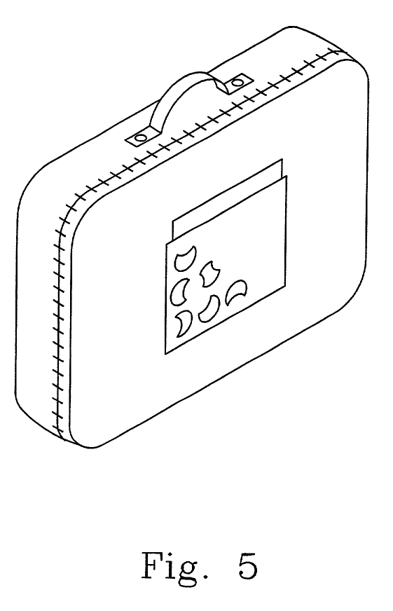

Preferably, the medium for decoration is attached to a cover of a briefcase as shown in FIG. 5.

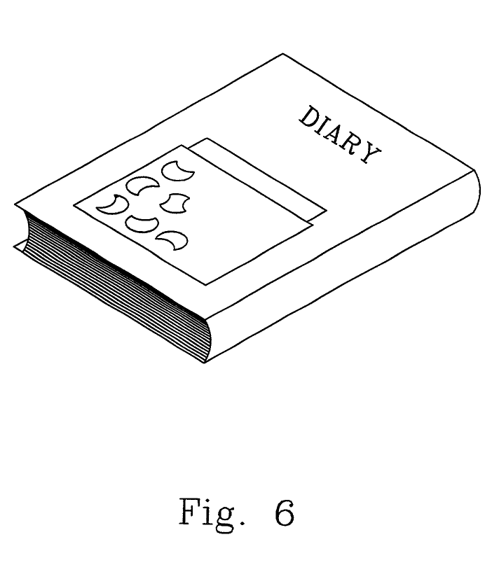

Preferably, the medium for decoration is attached to a cover of a diary as shown in FIG. 6.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A medium for decoration comprising:
a cover sheet having a cover color and a plurality of holes thereon so as to form a certain pattern; and
a colored sheet which is secured behind said cover sheet so that said colored sheet is exposed to said cover sheet through said plurality of holes.

2. The medium as claimed in claim 1, wherein each of said plurality of holes has a particular shape.

3. The medium as claimed in claim 1, wherein said plurality of holes have a particular distribution.

4. The medium as claimed in claim 1, wherein said plurality of holes are formed by die-cutting.

5. The medium as claimed in claim 1, wherein said medium is one half of a paper holder.

6. The medium as claimed in claim 1, wherein said colored sheet has an area smaller than that of the cover sheet.

7. A method for decoration comprising steps of:
a) preparing a cover sheet having a cover color and a plurality of holes thereon so as to form a certain pattern; and
b) preparing at least one replaceable colored sheet which is replaceably placed behind said cover sheet so that said colored sheet is exposed to said cover sheet through said plurality of holes.

8. The method as claimed in claim 7, wherein each of said plurality of holes has a particular shape.

9. The method as claimed in claim 7, wherein said plurality of holes have a particular distribution.

10. The method as claimed in claim 7, wherein said plurality of holes are formed by die-cutting.

11. A medium for decoration comprising:
a cover sheet having a cover color and a plurality of holes thereon so as to form a certain pattern; and
at least one replaceable colored sheet which is replaceably placed behind said cover sheet so that said colored sheet is exposed to said cover sheet through said plurality of holes.

12. The medium as claimed in claim 11, wherein each of said plurality of holes has a particular shape.

13. The medium as claimed in claim 11, wherein said plurality of holes have a particular distribution.

14. The medium as claimed in claim 11, wherein said plurality of holes are formed by die-cutting.

15. The medium as claimed in claim 11, wherein said medium is attached to a cover of a briefcase.

16. The medium as claimed in claim 11, wherein said medium is attached to a cover of a diary.
